(19) United States
(12) Patent Application Publication
(10) Pub. No.: US 2015/0339339 A1
(43) Pub. Date: Nov. 26, 2015

(54) INTEGRATING DATA FROM DATA SOURCES FOR ASSIGNING AN ENTITY TO A DATABASE RECORD

(71) Applicant: salesforce.com, inc., San Francisco, CA (US)

(72) Inventors: Alex Mastrodonato, San Francisco, CA (US); Helder Rocha, San Francisco, CA (US)

(73) Assignee: salesforce.com, inc., San Francisco, CA (US)

(21) Appl. No.: 14/286,576

(22) Filed: May 23, 2014

(51) Int. Cl. G06F 17/30; H04L 12/26; G06F 3/0484; H04L 12/58

(52) U.S. Cl. CPC G06F 17/30368; H04L 51/046; G06F 17/30289; H04L 43/08; G06F 17/30864; G06F 3/04842; G06F 17/303; G06F 17/30342

(57) ABSTRACT

Disclosed are methods, apparatus, systems, and computer readable storage media for integrating data from data sources for assigning an entity to a database record in a database service. User interface data can provide a user interface associated with a record stored using the database service, where the user interface includes a publisher and an information feed. An attribute regarding an entity is received from a first data source. Monitoring information for one or more machines is received from a second data source external to the database service, where the one or more machines are configured to communicate the monitoring information over a network. The record may be related to the one or more machines. The attribute and the monitoring information are provided to display in the user interface. User input data indicating a user input associated with the publisher is received to assign the entity to the record.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### TECHNICAL FIELD

This patent document relates generally to integrating data from data sources and, more specifically, to techniques for integrating data from data sources for assigning an entity to a database record in a database service using a user interface.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

Database resources can be provided in a cloud computing context. However, using conventional database management techniques, it is difficult to know about the activity of other users of a database system in the cloud or other network. For example, the actions of a particular user, such as a salesperson, on a database resource may be important to the user's boss. The user can create a report about what the user has done and send it to the boss, but such reports may be inefficient, not timely, and incomplete. Also, it may be difficult to identify other users who might benefit from the information in the report.

### BRIEF DESCRIPTION OF THE DRAWINGS

The included drawings are for illustrative purposes and serve only to provide examples of possible structures and operations for the disclosed inventive systems, apparatus, and methods for integrating data from data sources for assigning an entity to a database record in a database service. These drawings in no way limit any changes in form and detail that may be made by one skilled in the art without departing from the spirit and scope of the disclosed implementations.

FIG. 1A shows a block diagram of an example of an environment 10 in which an on-demand database service can be used in accordance with some implementations.

FIG. 1B shows a block diagram of an example of some implementations of elements of FIG. 1A and various possible interconnections between these elements.

FIG. 2A shows a system diagram illustrating an example of architectural components of an on-demand database service environment 200 according to some implementations.

FIG. 2B shows a system diagram further illustrating an example of architectural components of an on-demand database service environment according to some implementations.

FIG. 3 shows a flowchart of an example of a computer-implemented method 300 for integrating data from data sources for assigning an entity to a database record in a database service, according to some implementations.

FIG. 4 shows an example of a system diagram of components for integrating data from data sources for assigning an entity to a database record in a database service, according to some implementations.

FIGS. 5A-5F show a series of user interfaces illustrating a process flow for integrating data from data sources for assigning an entity to a database record in a database service, according to some implementations.

### DETAILED DESCRIPTION

Examples of systems, apparatus, and methods according to the disclosed implementations are described in this section. These examples are being provided solely to add context and aid in the understanding of the disclosed implementations. It will thus be apparent to one skilled in the art that implementations may be practiced without some or all of these specific details. In other examples, certain process/method operations, also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

As more users and organizations move toward collaborative data sharing models to communicate and conduct business, there is a desire to better collect and utilize information. With some of the disclosed implementations, rather than having to navigate between a plurality of different pages and screens to surface information from different data sources, such information may be surfaced to a single user interface on a user's device. As a result, a user can integrate information from multiple data points and efficiently utilize the integrated information. Especially in the context of a service or sales environment, integrating information from multiple data sources into a user interface can be useful when looking up information for a record stored in a database. The user can then quickly update the record, and notifications can be sent to appropriate recipients regarding the update. In some embodiments, the appropriate recipient can be a sales agent or service agent receiving the notification on a mobile phone or on a wearable display device.

Many electronic devices are configured to connect to networks so that data gathered or generated by the device can be transmitted over the network to various destinations. Such devices can be referred to as “connected devices.” For example, connected devices can communicate data to one or more instances in a cloud environment. Non-limiting examples of connected devices include a vehicle, a consumer appliance, a sensor, a robot, and other electronic products, each configured to gather and transmit data to an instance over a network. Other such examples of connected devices can include a toothbrush that can gather usage data, a car that can ascertain a maintenance issue, a printer that can detect when ink is running low, a GPS-enabled smartphone, etc. These connected devices can communicate data to a database service, and the data can be exposed in a user interface associated with the database service. For example, a customer service representative can quickly pull data from multiple data sources, including the exposed data from a connected device, and take action without having to navigate between multiple applications and interfaces. The user interface can include a publisher with an Application Programming Interface (API) configured to surface data from a plurality of data sources. Some of the data sources may be external to the database service, which means that the data sources can be maintained by entities other than the service provider providing the database service. In some embodiments, the API can be a mapping API so that a geolocation of the connected device may be surfaced.

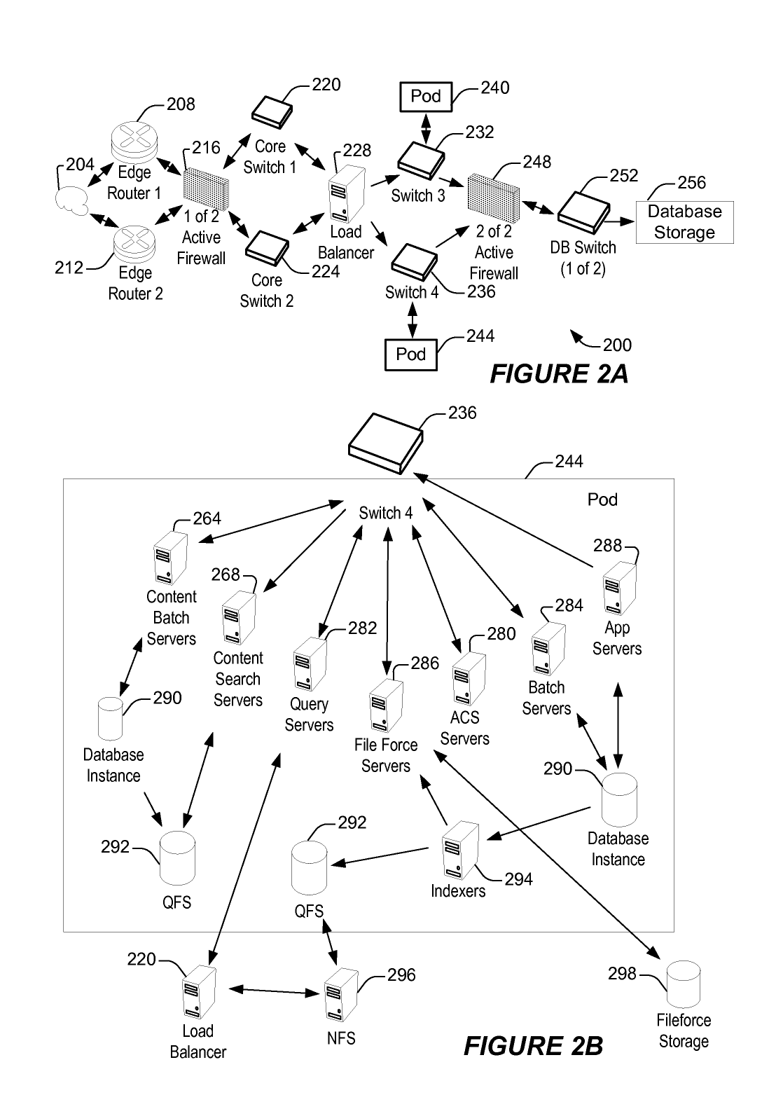

Each instance can refer to one or more devices having various types of hardware and/or software computing resources. Such instances can be referred to as “pods.” Each instance can be associated with a database service. Examples of the one or more devices in an instance can include but is not limited to a hardware load balancer, application servers, batch servers, database clusters, file servers, search query servers, search indexers, monitoring servers, and Hadoop servers. An instance associated with the database service may include those devices described with respect to pod 244 in FIG. 2B.

By way of example, a user interface for a CRM record such as a case can include a publisher and a case feed. The case is a record stored using the database service, and the case is associated with the connected device at issue. The publisher may have a publisher action for assigning an agent to the case. Selection of the publisher action can cause the publisher to display a map via a mapping API, such as a Google Maps API. Data identifying a connected device, such as an ultrasound machine, may be received and exposed in the user interface. Data identifying one or more agents in the vicinity of the connected device may also be received and exposed in the user interface, including each agent's geolocation, skill, and/or availability. The data for the connected device and the data for the one or more agents may be surfaced in the user interface through the mapping API. A customer service representative can view the exposed data and assign an appropriate agent to the case using the publisher. A notification regarding the assignment can be subsequently sent to the appropriate agent to alert the agent of the assignment. The notification may include not only the location of the connected device, but also information regarding the issue for the connected device. Upon receiving the notification, the agent may utilize the client device at which the agent received the notification to communicate in real-time with a customer service representative.

Various implementations described or referenced herein are directed to different methods, apparatus, systems, and computer-readable storage media for integrating data from multiple databases for interfacing with records in an on-demand database service. The on-demand database service can include online business applications and online social networks. An online social network is also referred to herein as a social networking system.

Online social networks are increasingly becoming a common way to facilitate communication among people, any of whom can be recognized as users of a social networking system. One example of an online social network is Chatter®, provided by salesforce.com, inc. of San Francisco, Calif. salesforce.com, inc. is a provider of social networking services, customer relationship management (CRM) services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some online social networks can be implemented in various settings, including organizations. For example, an online social network can be implemented to connect users within an enterprise such as a company or business partnership, or a group of users within such an organization. For example, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some online social networks, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, an online social network may allow a user to follow data objects in the form of records such as cases, accounts, or opportunities, in addition to following individual users and groups of users. The “following” of a record stored in a database, as described in greater detail below, allows a user to track the progress of that record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be user-submitted messages or can otherwise be generated in response to user actions or in response to events. Examples of messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For example, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of an online social network. For example, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within an online social network, an email notification or other type of network communication may be transmitted to all users following the user, group, or object in addition to the inclusion of the data as a feed item in one or more feeds, such as a user's profile feed, a news feed, or a record feed. In some online social networks, the occurrence of such a notification is limited to the first instance of a published input, which may form part of a larger conversation. For example, a notification may be transmitted for an initial post, but not for comments on the post. In some other implementations, a separate notification is transmitted for each such information update.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “information feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different information feeds. A second user following a first user and a record can receive the feed items associated with the first user and the record for display in the second user's news feed, which is another type of information feed. In some implementations, the feed items from any number of followed users and records can be combined into a single information feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for example, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

I. General Overview

Systems, apparatus, and methods are provided for implementing enterprise level social and business information networking. Such implementations can provide more efficient use of a database system. For example, a user of a database system may not easily know when important information in the database has changed, e.g., about a project or client. Implementations can provide feed tracked updates about such changes and other events, thereby keeping users informed.

By way of example, a user can update a record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed right to the manager's feed page or other page.

Next, mechanisms and methods for providing systems implementing enterprise level social and business information networking will be described with reference to several implementations. First, an overview of an example of a database system is described, and then examples of tracking events for a record, actions of a user, and messages about a user or record are described. Various implementations about the data structure of feeds, customizing feeds, user selection of records and users to follow, generating feeds, and displaying feeds are also described.

II. System Overview

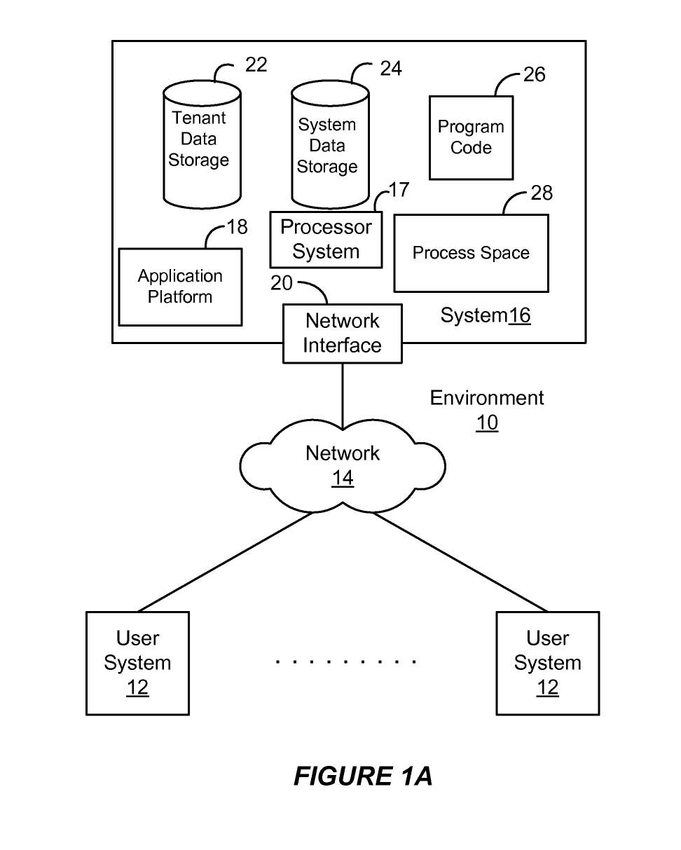

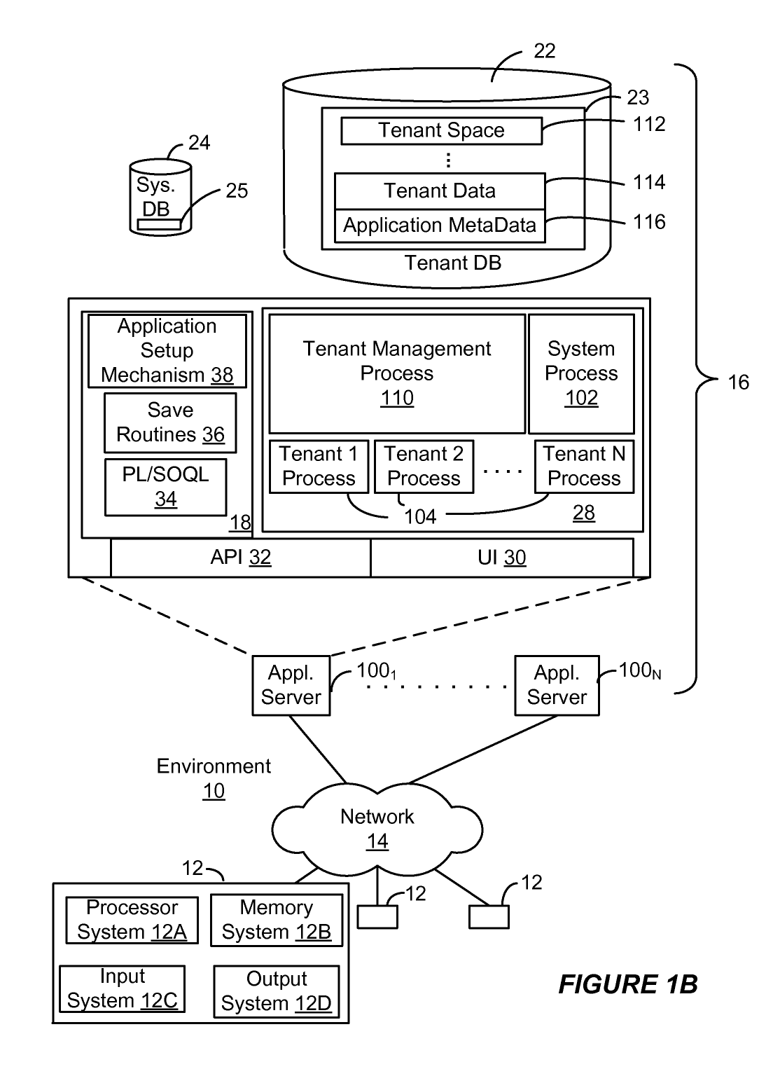

FIG. 1A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 1A (and in more detail in FIG. 1B) user systems 12 might interact via a network 14 with an on-demand database service, which is implemented in the example of FIG. 1A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 1A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 1A and 1B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some embodiments, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 1B shows a block diagram of an example of some implementations of elements of FIG. 1A and various possible interconnections between these elements. That is, FIG. 1B also illustrates environment 10. However, in FIG. 1B elements of system 16 and various interconnections in some implementations are further illustrated. FIG. 1B shows that user system 12 may include processor system 12A, memory system 12B, input system 12C, and output system 12D. FIG. 1B shows network 14 and system 16. FIG. 1B also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 1001-100N, system process space 102, tenant process spaces 104, tenant management process space 110, tenant storage space 112, user storage 114, and application metadata 116. In other implementations, environment 10 may not have the same elements as those listed above and/or may have other elements instead of, or in addition to, those listed above.

User system 12, network 14, system 16, tenant data storage 22, and system data storage 24 were discussed above in FIG. 1A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 1B, system 16 may include a network interface 20 (of FIG. 1A) implemented as a set of HTTP application servers 100, an application platform 18, tenant data storage 22, and system data storage 24. Also shown is system process space 102, including individual tenant process spaces 104 and a tenant management process space 110. Each application server 100 may be configured to communicate with tenant data storage 22 and the tenant data 23 therein, and system data storage 24 and the system data 25 therein to serve requests of user systems 12. The tenant data 23 might be divided into individual tenant storage spaces 112, which can be either a physical arrangement and/or a logical arrangement of data. Within each tenant storage space 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage space 112. A UI 30 provides a user interface and an API 32 provides an application programmer interface to system 16 resident processes to users and/or developers at user systems 12. The tenant data and the system data may be stored in various databases, such as one or more Oracle| databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 1001 might be coupled via the network 14 (e.g., the Internet), another application server 100N-1 might be coupled via a direct network link, and another application server 100N might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain implementations, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one implementation, therefore, an interface system implementing a load balancing function (e.g., an F5 Big-IP load balancer) is communicably coupled between the application servers 100 and the user systems 12 to distribute requests to the application servers 100. In one implementation, the load balancer uses a least connections algorithm to route user requests to the application servers 100. Other examples of load balancing algorithms, such as round robin and observed response time, also can be used. For example, in certain implementations, three consecutive requests from the same user could hit three different application servers 100, and three requests from different users could hit the same application server 100. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 100 to request and update system-level and tenant-level data from system 16 that may involve sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 2A shows a system diagram illustrating an example of architectural components of an on-demand database service environment 200 according to some implementations. A client machine located in the cloud 204, generally referring to one or more networks in combination, as described herein, may communicate with the on-demand database service environment via one or more edge routers 208 and 212. A client machine can be any of the examples of user systems 12 described above. The edge routers may communicate with one or more core switches 220 and 224 via firewall 216. The core switches may communicate with a load balancer 228, which may distribute server load over different pods, such as the pods 240 and 244. The pods 240 and 244, which may each include one or more servers and/or other computing resources, may perform data processing and other operations used to provide on-demand services. Communication with the pods may be conducted via pod switches 232 and 236. Components of the on-demand database service environment may communicate with a database storage 256 via a database firewall 248 and a database switch 252.

As shown in FIGS. 2A and 2B, accessing an on-demand database service environment may involve communications transmitted among a variety of different hardware and/or software components. Further, the on-demand database service environment 200 is a simplified representation of an actual on-demand database service environment. For example, while only one or two devices of each type are shown in FIGS. 2A and 2B, some implementations of an on-demand database service environment may include anywhere from one to many devices of each type. Also, the on-demand database service environment need not include each device shown in FIGS. 2A and 2B, or may include additional devices not shown in FIGS. 2A and 2B.

Moreover, one or more of the devices in the on-demand database service environment 200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 204 is intended to refer to a data network or plurality of data networks, often including the Internet. Client machines located in the cloud 204 may communicate with the on-demand database service environment to access services provided by the on-demand database service environment. For example, client machines may access the on-demand database service environment to retrieve, store, edit, and/or process information.

In some implementations, the edge routers 208 and 212 route packets between the cloud 204 and other components of the on-demand database service environment 200. The edge routers 208 and 212 may employ the Border Gateway Protocol (BGP). The BGP is the core routing protocol of the Internet. The edge routers 208 and 212 may maintain a table of IP networks or ‘prefixes’, which designate network reachability among autonomous systems on the Internet.

In one or more implementations, the firewall 216 may protect the inner components of the on-demand database service environment 200 from Internet traffic. The firewall 216 may block, permit, or deny access to the inner components of the on-demand database service environment 200 based upon a set of rules and other criteria. The firewall 216 may act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 may be configured as network bridges that quickly route data between different components within the on-demand database service environment. In some implementations, the use of two or more core switches 220 and 224 may provide redundancy and/or reduced latency.

In some implementations, the pods 240 and 244 may perform the core data processing and service functions provided by the on-demand database service environment. Each pod may include various types of hardware and/or software computing resources. An example of the pod architecture is discussed in greater detail with reference to FIG. 2B.

In some implementations, communication between the pods 240 and 244 may be conducted via the pod switches 232 and 236. The pod switches 232 and 236 may facilitate communication between the pods 240 and 244 and client machines located in the cloud 204, for example via core switches 220 and 224. Also, the pod switches 232 and 236 may facilitate communication between the pods 240 and 244 and the database storage 256.

In some implementations, the load balancer 228 may distribute workload between the pods 240 and 244. Balancing the on-demand service requests between the pods may assist in improving the use of resources, increasing throughput, reducing response times, and/or reducing overhead. The load balancer 228 may include multilayer switches to analyze and forward traffic.

In some implementations, access to the database storage 256 may be guarded by a database firewall 248. The database firewall 248 may act as a computer application firewall operating at the database application layer of a protocol stack. The database firewall 248 may protect the database storage 256 from application attacks such as structure query language (SQL) injection, database rootkits, and unauthorized information disclosure.

In some implementations, the database firewall 248 may include a host using one or more forms of reverse proxy services to proxy traffic before passing it to a gateway router. The database firewall 248 may inspect the contents of database traffic and block certain content or database requests. The database firewall 248 may work on the SQL application level atop the TCP/IP stack, managing applications' connection to the database or SQL management interfaces as well as intercepting and enforcing packets traveling to or from a database network or application interface.

In some implementations, communication with the database storage 256 may be conducted via the database switch 252. The multi-tenant database storage 256 may include more than one hardware and/or software components for handling database queries. Accordingly, the database switch 252 may direct database queries transmitted by other components of the on-demand database service environment (e.g., the pods 240 and 244) to the correct components within the database storage 256.

In some implementations, the database storage 256 is an on-demand database system shared by many different organizations. The on-demand database system may employ a multi-tenant approach, a virtualized approach, or any other type of database approach. An on-demand database system is discussed in greater detail with reference to FIGS. 1A and 1B.

FIG. 2B shows a system diagram further illustrating an example of architectural components of an on-demand database service environment according to some implementations. The pod 244 may be used to render services to a user of the on-demand database service environment 200. In some implementations, each pod may include a variety of servers and/or other systems. The pod 244 includes one or more content batch servers 264, content search servers 268, query servers 282, file force servers 286, access control system (ACS) servers 280, batch servers 284, and app servers 288. Also, the pod 244 includes database instances 290, quick file systems (QFS) 292, and indexers 294. In one or more implementations, some or all communication between the servers in the pod 244 may be transmitted via the switch 236.

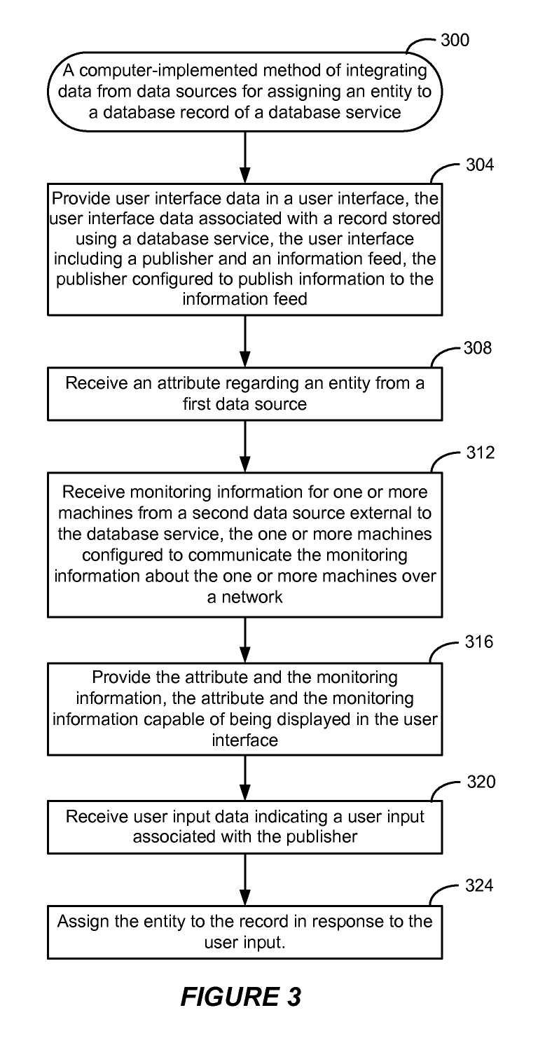

In some implementations, the app servers 288 may include a hardware and/or software framework dedicated to the execution of procedures (e.g., programs, routines, scripts) for supporting the construction of applications provided by the on-demand database service environment 200 via the pod 244. In some implementations, the hardware and/or software framework of an app server 288 is configured to execute operations of the services described herein, including performance of the blocks of methods described with reference to FIGS. 3-8B. In alternative implementations, two or more app servers 288 may be included and cooperate to perform such methods, or one or more other servers described herein can be configured to perform the disclosed methods.

The content batch servers 264 may handle requests internal to the pod. These requests may be long-running and/or not tied to a particular customer. For example, the content batch servers 264 may handle requests related to log mining, cleanup work, and maintenance tasks.

The content search servers 268 may provide query and indexer functions. For example, the functions provided by the content search servers 268 may allow users to search through content stored in the on-demand database service environment.

The file force servers 286 may manage requests for information stored in the Fileforce storage 298. The Fileforce storage 298 may store information such as documents, images, and basic large objects (BLOBs). By managing requests for information using the file force servers 286, the image footprint on the database may be reduced.

The query servers 282 may be used to retrieve information from one or more file systems. For example, the query system 282 may receive requests for information from the app servers 288 and then transmit information queries to the NFS 296 located outside the pod.

The pod 244 may share a database instance 290 configured as a multi-tenant environment in which different organizations share access to the same database. Additionally, services rendered by the pod 244 may call upon various hardware and/or software resources. In some implementations, the ACS servers 280 may control access to data, hardware resources, or software resources.

In some implementations, the batch servers 284 may process batch jobs, which are used to run tasks at specified times. Thus, the batch servers 284 may transmit instructions to other servers, such as the app servers 288, to trigger the batch jobs. In some implementations, the QFS 292 may be an open source file system available from Sun Microsystems® of Santa Clara, Calif. The QFS may serve as a rapid-access file system for storing and accessing information available within the pod 244. The QFS 292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 268 and/or indexers 294 to identify, retrieve, move, and/or update data stored in the network file systems 296 and/or other storage systems.

In some implementations, one or more query servers 282 may communicate with the NFS 296 to retrieve and/or update information stored outside of the pod 244. The NFS 296 may allow servers located in the pod 244 to access information to access files over a network in a manner similar to how local storage is accessed.

In some implementations, queries from the query servers 222 may be transmitted to the NFS 296 via the load balancer 228, which may distribute resource requests over various resources available in the on-demand database service environment. The NFS 296 may also communicate with the QFS 292 to update the information stored on the NFS 296 and/or to provide information to the QFS 292 for use by servers located within the pod 244.

In some implementations, the pod may include one or more database instances 290. The database instance 290 may transmit information to the QFS 292. When information is transmitted to the QFS, it may be available for use by servers within the pod 244 without using an additional database call.

In some implementations, database information may be transmitted to the indexer 294. Indexer 294 may provide an index of information available in the database 290 and/or QFS 292. The index information may be provided to file force servers 286 and/or the QFS 292.

III. Integrating Data from Data Sources for Assigning an Entity to a Database Record

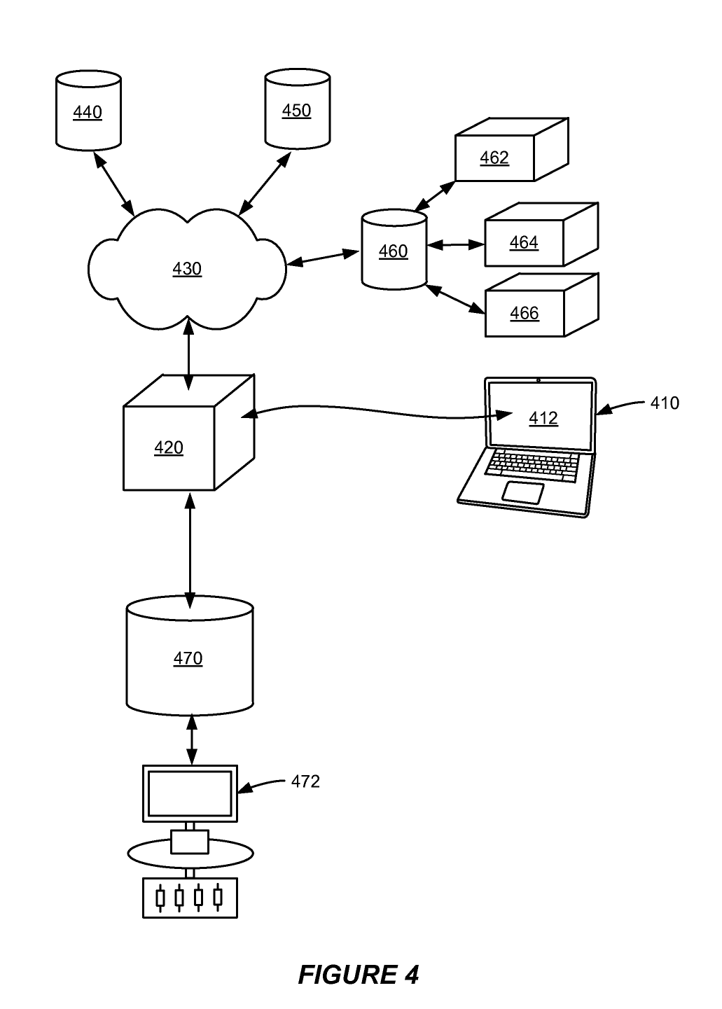

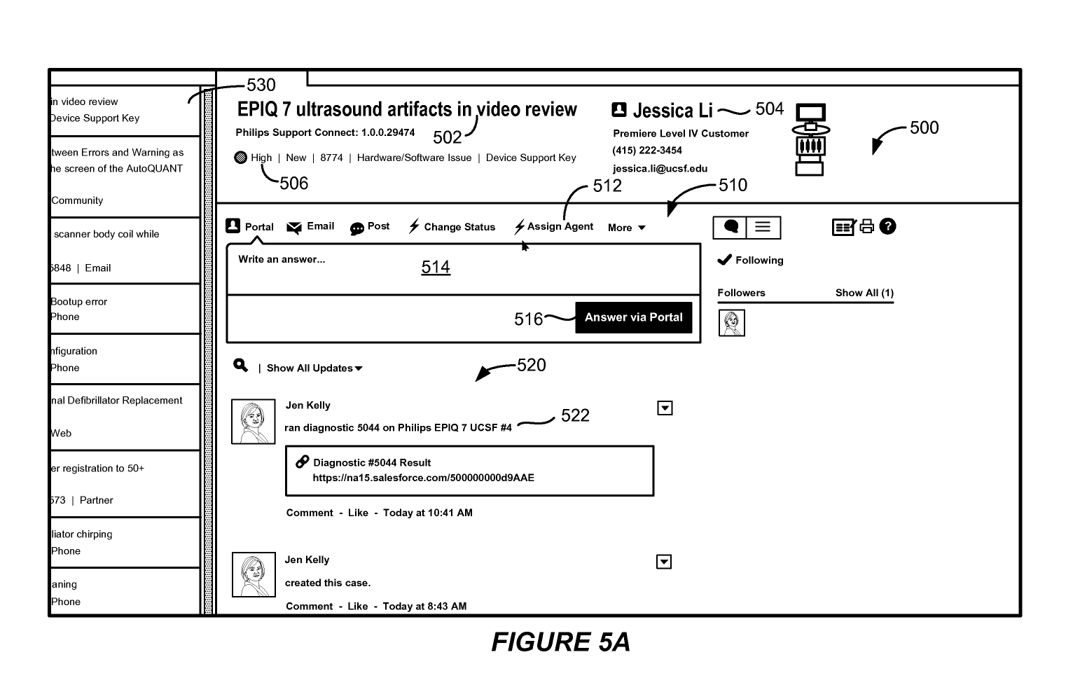

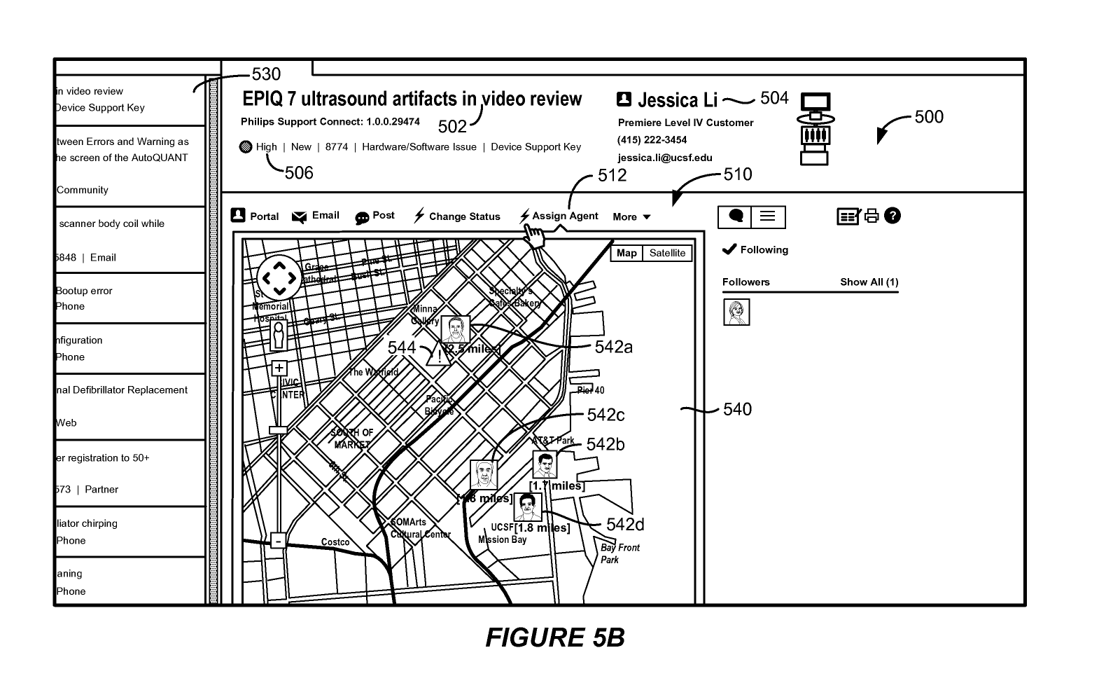

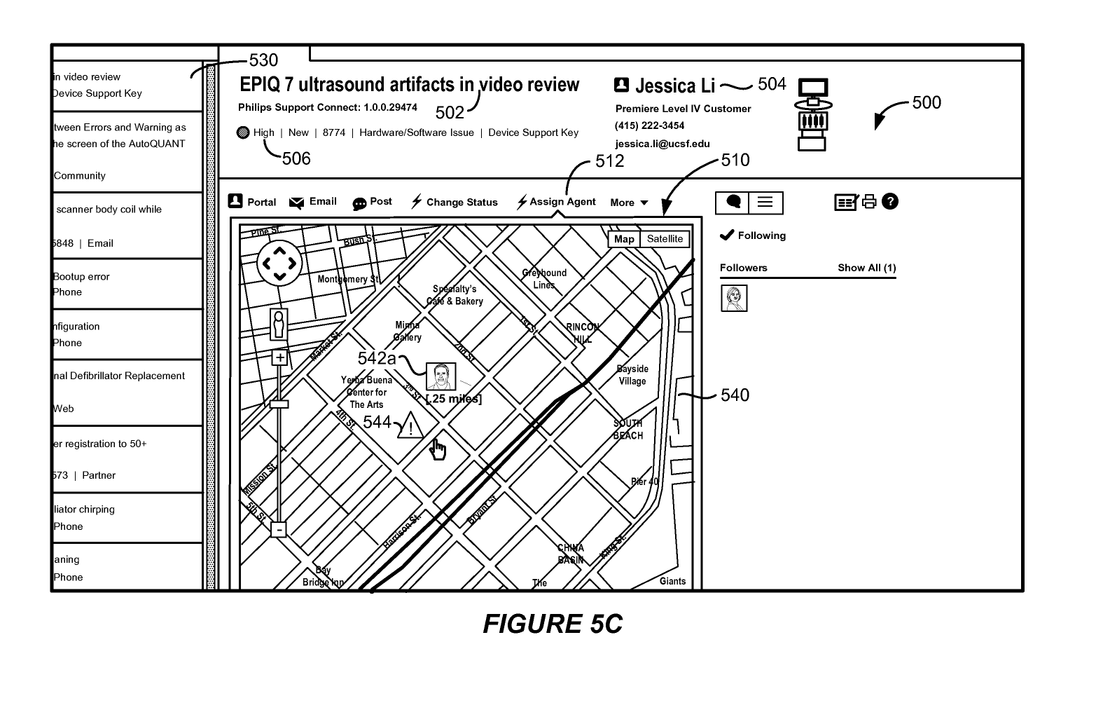

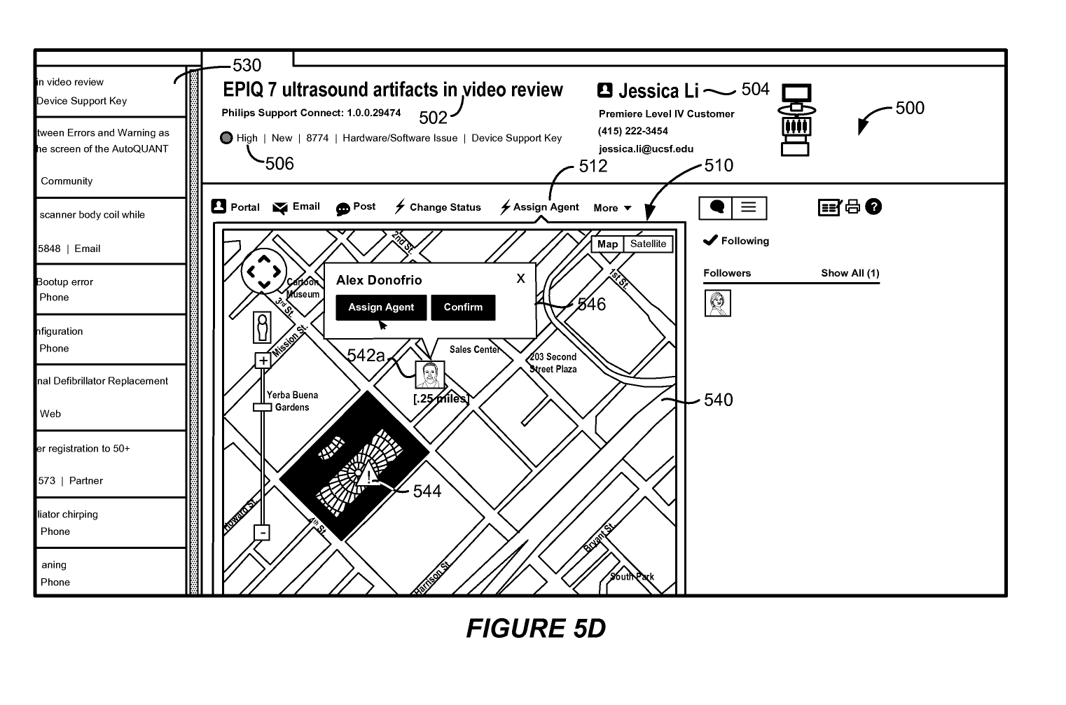

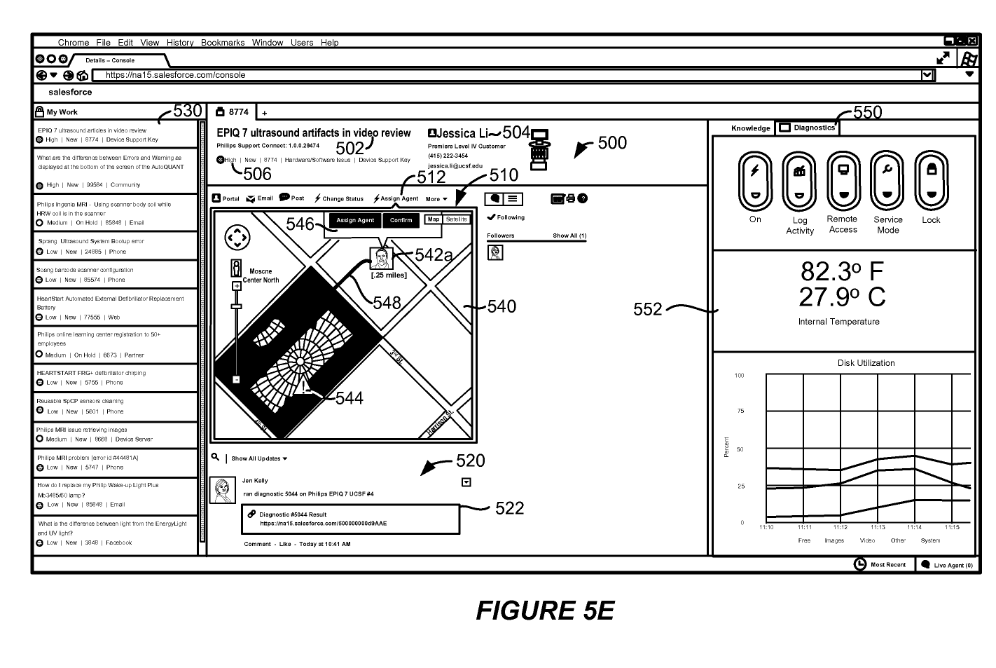

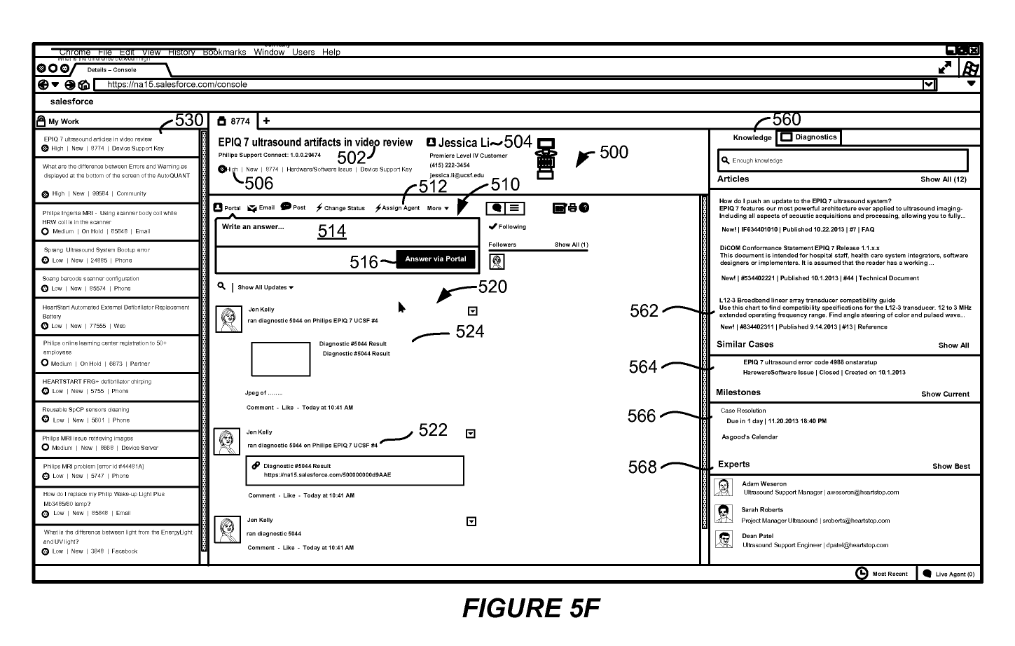

FIG. 3 shows a flowchart of an example of a computer-implemented method 300 for integrating data from data sources for assigning an entity to a database record of a database service, according to some implementations. FIG. 3 shows a high-level overview of the types of operations that may be performed for integrating data from a plurality of data sources for updating a record of a database service. The operations in the method 300 may be performed in different orders and/or with different, fewer, or additional operations. FIG. 3 may be described with reference to the examples illustrated in FIGS. 4 and 5A-5F.

At block 304, an instance or any number of instances cooperating to perform the method 300 and associated with the database service may provide user interface data in a user interface. The user interface data may be associated with a record stored using a database service. The user interface can include a publisher and an information feed, where the publisher is configured to publish information to the information feed. The user interface may be part of a page layout for a record in the database service.

Typically, a publisher includes one or more publisher actions that enable a user to update or otherwise perform an action on the record. For example, a publisher action can permit a user to change data in a data field. Other examples of actions can include the creation of the record, deletion of the record, converting the record from one type to another, closing the record, and performing any other state change to the record. Any of these actions can update the record. In some implementations, the record can be a CRM object, such as a lead, a case, an account, an opportunity, a task, a contact, a campaign, a contract, an event, and a custom object.

In some implementations, a user in the database service may create a custom action using an API provided by the database service. The user may define custom action instructions for interacting with a data object (e.g., record) in the database service and/or a custom object. The custom action with user-defined custom action instructions may be provided with the publisher in the user interface. A more detailed description of custom actions provided with the publisher can be found in U.S. application Ser. No. 13/943,636 entitled, “SYSTEMS AND METHODS FOR CREATING CUSTOM ACTIONS” to Beechuk et al., filed Jul. 16, 2013, the entirety of which is incorporated by reference herein and for all purposes.

A custom action can be created to permit data from external data sources to surface in a publisher space of the publisher. Selection of the custom action can cause the publisher to expose an application or interface in the publisher space. The API provided by the database service can enable integration of a third-party application into the database service. Thus, data from the third-party application can communicate with the browser page of the publisher as if the third-party application were hosted in the database service. For example, the third-party application can be a mapping application.

FIG. 5A shows an example of a user interface 500 that includes a publisher 510 and an information feed 520 for a case 502. The user interface 500 may be caused to display in a display device upon selection of a tab 530 corresponding to the case 502. The user interface 500 may be part of a service console and the display device may be associated with a customer service representative. The case 502 can include various data items 504 and 506 associated with the case 502, which can be displayed in the user interface 500. As shown in FIG. 5A, the case 502 can correspond to EPIQ 7 ultrasound artifacts in video review. The case 502 can include the data item 504 corresponding to a customer Jessica Li, where the data item 504 can be accompanied by the customer's contact information and the customer's account level. The case 502 can also include the data item 506 that provides more description about the case 502, such as the importance of the issue, the type of issue, etc.

In FIG. 5A, the publisher 510 includes a plurality of publisher actions 512. Some of the publisher actions 512 may be custom actions that serve as actions enabled by the API for the publisher 510. The publisher actions 512 may be configured to allow a user to make a request to update or otherwise interact with the case 502. As shown in FIG. 5A, the publisher actions 512 can include answering an inquiry to a web portal, composing an email to a customer, posting to an online social network, changing the status of the case, assigning an agent to the case, and more. For example, selection of the publisher action 512 for answering an inquiry to a web portal may cause the publisher 510 to display a text space 514 for composing a message. The publisher 510 may also include a button 516 for submitting the message to the web portal.

The user interface 500 may also include an information feed 520 that includes a plurality of feed items 522. Information provided in the publisher 510 may be published to the information feed 520. The information feed 520 can be a case feed that includes updates or other events to the case 502 or related to the case 502. In some implementations, the information feed 520 for the case 502 can be stored in a database associated with the database service. For example, the information feed 520 can be stored as a field of the case 502. When the feed items 522 are provided in the information feed 520, they can be filtered so that only certain feed items 522 are displayed.

Returning to FIG. 3, at block 308, an attribute regarding an entity may be received from a first data source. In some implementations, the first data source can be a database associated with the database service. The database service can include, for example, an online social network or an online business application. The database service can be managed and controlled by a database service provider, such as salesforce.com. Data objects and data items associated with the data objects may be pulled from the first data source, where data items may include values for one or more metadata fields associated with the data objects.

Data items from the first data source may be related to the entity, where the entity can be a user in the database service. For example, the data items may be pulled from user records or other records that include pertinent information regarding the entity. Pertinent information regarding the entity may be found in one or more data objects in the first data source so that information regarding the entity can be accessed and received by one or more instances of the database service. The pertinent information can include attributes regarding the entity, where the attributes can include a geolocation, a skill, and an availability. In some implementations, the first data source can include one or more of a skills database and a calendar object associated with the database service.

In some implementations, the attribute can include a schedule of availability for a user (e.g., a field agent) in the database service. For example, the attribute may include time frames in which the user is available. The one or more instances associated with the database service may access and receive calendar information for the user from a calendar object. The one or more instances may process the calendar information to ascertain the schedule of availability for the user.

In some implementations, the attribute can include one or more skills associated with a user (e.g., field agent) in the database service. The one or more instances associated with the database service may access and receive user information from the first data source, where the first data source can include a skills database and/or a profile object. Thus, the user information can provide skills that a user possesses in the database service.

In some implementations, the one or more instances associated with the database service may access and receive other data items from the first data source associated with the database service. Such data items can include but are not limited to a type of account associated with a user, historical actions performed by a user, tasks/projects that the user is a part of, locations the user is assigned to, customers the user is assigned to, a geolocation of the user, roles/responsibilities of the user, and preferences of the user, among others.

In addition or in the alternative, the first data source can include a client device associated with the entity. In some implementations, the client device associated with the entity may be connected to the database service via a network connection. The client device may include any one of a number of electronic devices, including a smartphone, a laptop, a tablet, a wearable display device, and a desktop computer. The client device associated with the entity may communicate an attribute regarding the entity to the database service over a network.

In some implementations, the attribute can include a geolocation of a user (e.g., field agent). The one or more instances associated with the database service may receive the geolocation of the user from the client device. A geographic location of the client device may be ascertained using radio frequency (RF) location methods in order to associate the geographic location with the Internet Protocol (IP) address, MAC address, RFID, hardware embedded article/production number, embedded software number, invoice, Wi-Fi positioning system, device global positioning system (GPS) coordinates, or other self-disclosed information. A location-based service may apply the geographic location and the time to provide real-time positioning of the client device. Hence, identification of the geographic location of the client device may provide the geolocation of the user associated with the client device. In some implementations, the geolocation of the user associated with the client device may update a data field in the database associated with the database service. The one or more instances associated with the database service may receive the geolocation from the data field in the database. Alternatively, the one or more instances associated with the database service may receive the geolocation of the user directly from the client device.

At block 312, monitoring information for one or more machines may be received from a second data source external to the database service. The one or more machines may include one or more of a: vehicle, an appliance, a sensor, a robot, and an electronic product. The record may be related to the one or more machines. For example, the record may include information about the one or more machines, its usage, its manufacturer, a user associated with the one or more machines, etc.

The one or more machines may be configured to communicate monitoring information regarding the one or more machines over a network. The monitoring information may be communicated from the one or more machines using a radio frequency transmitter. In some implementations, the one or more machines may be part of or otherwise connected to a monitoring device. The second data source can include the monitoring device. The monitoring device may be capable of connectivity (e.g., wired or wirelessly) to the network to communicate the monitoring information regarding the one or more machines. Monitoring devices can include a mobile phone, a laptop, a tablet, a wearable display device, a desktop computer, etc.

The one or more machines may be capable of gathering, storing, and/or recording monitoring information about the one or more machines. Examples of such monitoring information about the one or more machines can include geolocation, diagnostic information, user information, and historical information. In some implementations, the one or more machines may be equipped with one or more sensors for gathering information. By way of an example, a toothbrush may be equipped with an accelerometer to measure brushing patterns. In another example, a printer may be equipped with a sensor to detect when ink is running low. In yet another example, a smartphone may be equipped with a location module that may interact with other components to ascertain a real-time position of the smartphone. Many other machines may be capable of collecting monitoring information regarding the machines to communicate over a network. The collected information may be sent to the second data source, and the second data source may communicate the collected monitoring information to the database service. The collected monitoring information may be communicated to the one or more instances associated with the database service. In some implementations, the collected monitoring information may be processed and analyzed by the second data source prior to communicating with the one or more instances. In some implementations, the collected information may be processed and analyzed by the one or more instances associated with the database service.

The second data source may serve as a data storage that collects the monitoring information regarding the one or more machines. The second data source may be external to the database service, where “external” can refer to data sources maintained by entities other than the service provider providing the given database service. In some implementations, the data source is external in that it is be hosted on a network domain separate from the network domain of the database service. The collected monitoring information may be sent to the database service via a network transmission. In some implementations, the collected monitoring information may be stored as a data object (e.g., asset object) in the database.

For example, an ultrasound machine may send over diagnostic information regarding the ultrasound machine to the second data source. The second data source can process and aggregate the diagnostic information to report the diagnostic information to the one or more instances associated with the database service via a network transmission. In some implementations, the diagnostic information is communicated and stored in a database in the database service. As a result, the database service may have access to and may integrate data native to the database service and data external to the database service. The diagnostic information may be stored in an asset object associated with the database service. Other monitoring information may be communicated and stored in the asset object, including a geolocation of the ultrasound machine.

At block 316, the attribute and the monitoring information may be provided, where the attribute and monitoring information are capable of being displayed in the user interface. The one or more instances associated with the database service may provide the attribute and the monitoring information to the user interface. The one or more instances associated with the database service may cause the attribute and the monitoring information to be simultaneously displayed in the user interface of the display device. Thus, data from a plurality of data sources may be surfaced in the user interface. This can allow a user associated with the display device to look up information from multiple data sources in the publisher without having to navigate through multiple screens and interfaces. In some implementations, the attribute and the monitoring information may be provided in the publisher of the user interface. Where the publisher includes a publisher action, selection of the publisher action may be configured to cause the publisher to provide the attribute and the monitoring information in the user interface.

The publisher may be capable of exposing content from a third-party application via an API. In some implementations, the publisher may use a mapping API, where the mapping API is configured to enable integration of a mapping application with the database service. In some implementations, providing the attribute and the monitoring information includes providing the attribute and monitoring information capable of being displayed in the publisher via the mapping API.

FIG. 4 shows an example of a system diagram of components for integrating data from data sources for assigning an entity to a database record in a database service, according to some implementations. A database service, such as an on-demand database service, can exist in an environment 430. The environment 430 can be a cloud environment having a database storing a plurality of objects 440, 450, and 460 and one or more instances 420 associated with the database service. The database may be running on the one or more instances 420 associated with the database service. The object 460 may be a profile object or other data object regarding the entity that may be synchronized with one or more first data sources 462, 464, and 466. A data source 462 can include a client device associated with the entity that provides the entity's geolocation. A data source 464 may represent a calendar object or scheduler that provides the entity's schedule of availability. A data source 466 may represent a skills database that provides the entity's list of skills.

In addition, a case object 440 may represent the record in the database service, where the case object 440 may include case information and a case feed. An asset object 450 may include data from a second data source 470. A machine 472 may be in communication with a second data source 470. The machine 472 may communicate monitoring information over a network to the second data source 470, where the monitoring information can include at least one of a geolocation, diagnostic information, user information, and historical information about the machine 472. In some implementations, the machine 472 may be referred to as a connected device. The machine can include a vehicle, an appliance, a sensor, a robot, or an electronic product. The second data source can be a remote data storage that processes the monitoring information. In some implementations, the processed monitoring information can be provided from the second data source 470 to the asset object 450 in the environment 430, where the second data source 470 may be outside of the environment 430.

Data from the environment 430 may be provided from any of the objects 440, 450, and 460 through the one or more instances 420 associated with the database service, where the data from the environment 430 can include attributes regarding the entity. The monitoring information from the second data source 470 and the data from the environment 430 may be communicated through the one or more instances 420 to a display device 410. The display device may be capable of displaying the monitoring information about the machine 472 and the data from the environment 430 regarding the entity in the user interface 412 of the display device 410. Thus, data from at least two different data sources may be surfaced in the display device 410.

FIG. 5B shows an example of the user interface 500 from FIG. 5A upon selection of a custom action 512 for the case 502. When a user selects Assign Agent with respect to the publisher 510, a publisher space 540 of the publisher 510 can present a map. The map can be provided via a mapping API, such as a Google Maps API. The map in the publisher space 540 can include a plurality of field agents 542a, 542b, 542c, and 542d within proximity to a machine 544. As illustrated in the example in FIG. 5B, the field agent 542a is located within 0.25 miles of the machine 544, whereas the field agents 542b, 542c, and 542d are located over 1.5 miles from the machine 544.

Each of the field agents 542a, 542b, 542c, and 542d can be represented on the map according to their geolocation. The geolocation can be provided by a field agent's mobile phone or wearable display device, such as Google Glasses. By integrating a mapping application like Google Maps with the publisher 510, each field agent's geolocation can provide a real-time position of the field agent on the map. In addition, a geolocation of the machine 544 can be provided by the machine 544 and its real-time position can surface in the map. In some implementations, the geolocation of the field agents 542a, 542b, 542c, and 542d and the machine 544 can be provided to the database service and integrated with the mapping application. In some implementations, the geolocation of the field agents 542a, 542b, 542c, and 542d and the machine 544 can be stored in data fields of data objects (e.g., profile objects, asset objects, etc.) associated with the database service.

FIG. 5C shows an example of the user interface 500 from FIGS. 5A and 5B upon zooming in toward the field agent 542a and the machine 544. The mapping application provided in the publisher space 540 can be interactive to permit a user to navigate the map and zoom in/out of the map. Thus, the user can zoom in closer to the machine 544 and to the field agent 542a to ascertain a more precise location of each.

Returning to FIG. 3, at block 320, user input data may be received indicating a user input associated with the publisher. The user input data can indicate a selection for causing an action to be performed to update the record. For example, the user input data can indicate a selection for assigning the entity to the record. The user input data can be transmitted to one or more instances associated with the database service with instructions to perform the update to the record. The user input data can also cause an action to be performed to update not only the record, but other objects associated with the database service.

FIG. 5D shows an example of the user interface 500 from FIGS. 5A-5C upon selection of the field agent 542a. The user may select the field agent 542a to cause a component 546 to appear on the map in the publisher space 540. The component 546 may be a pop-up window permitting the user to view the name of the selected field agent 542a and to select Assign Agent or Confirm. If the user selects Assign Agent, the selection can cause the field agent 542a to be assigned to the case 502.

In some implementations, selection of the field agent 542a can cause the component 546 to appear and display other attributes regarding the field agent 542a. In one example, the component 546 can display a schedule of availability of the field agent 542a. In another example, the component 546 can display a list of skill sets of the field agent 542a. The skill sets can be specific to the types of machines the field agent 542a has knowledge and experience with, specific to the customers and clients the field agent 542a has worked with, specific to the past history of projects and tasks the field agent 542a has completed or working on, etc. Here, the user can select one of the field agents 542a, 542b, 542c, and 542d with knowledge of the machine 544 in question.

It is understood that any number of attributes regarding the field agent 542a can be surfaced in the component 546, or more generally in the publisher space 540. Other attributes can include a type of account associated with a user, historical actions performed by a field agent 542a, tasks/projects that the field agent 542a is a part of, locations that the field agent 542a is assigned to, customers the field agent 542a is assigned to, a geolocation of the field agent 542a, roles/responsibilities of the field agent 542a, and preferences of the field agent 542a. The attributes can be ascertained and tracked within the database service. In some implementations, the database service can include a plurality of data objects from which the attributes regarding a field agent 542a can be ascertained and tracked. In some implementations, third-party applications can be integrated with the database service to ascertain some of the attributes, such as third-party applications that track a field agent's time sheet, calendar, skill sets, geolocation, etc.

In some implementations, a logic can be applied to filter the appropriate field agents 542a, 542b, 542c, and 542d according to one or more attributes regarding the field agents 542a, 542b, 542c, and 542d. The logic can be automatically applied as a set of instructions upon selection of the custom action 512. The logic can be configured to filter field agents according to those within certain proximity of the machine 544, those having a particular skill set with respect to the machine 544, and those having an appropriate availability for servicing the machine 544. The user can customize the logic according to one or more attributes so that any field agents lacking certain attributes can be filtered. Thus, the field agents 542a, 542b, 542c, and 542d can be presented in the map having appropriate attributes after applying the logic. Field agents without the appropriate attributes will not be displayed in the map.

The map in the publisher space 540 can be interactive to permit the drawing of a route between the field agent 542a and the machine 544. FIG. 5E illustrates a route 548 that can be represented in the map between the field agent 542a and the machine 544. Accordingly, the route 548 can be saved and published to the information feed 520 or otherwise sent to the field agent 542a so that the field agent 542a can see the route 548 to the machine 544 on their client device.

While the publisher 510 can surface data regarding any of the field agents in the publisher space 540, the publisher 510 can also surface data regarding the machine 544. FIG. 5E shows an example of the user interface 500 from FIGS. 5A-5D with monitoring information 550 about the machine 544. As shown in FIG. 5E, the monitoring information 550 can include diagnostic information 552 about the EPIQ 7 ultrasound machine. The diagnostic information 552 can be displayed in a portion of the user interface 500 separate from the publisher space 540 and separate from the information feed 520. The diagnostic information 552 can report a log activity of the EPIQ 7 ultrasound. Sensors in the EPIQ 7 ultrasound can report additional monitoring information, such as the internal temperature of the EPIQ 7 ultrasound, the average time used per day, the number of restarts, etc. Having such diagnostic information 552 readily available to the user can assist the user in diagnosing and troubleshooting issues regarding the machine 544. The monitoring information 550 may provide an interface for not only reporting monitoring information 550 about the machine 544, but also for interacting remotely with the machine 544.

In some implementations, the user interface 500 can have a plurality of components so that at least one of the components can expose content from a data source external to the database service. Cross-domain communication with the data source external to the database service can occur via an API, such as a cross-domain API. In some implementations, the data source can be a remote data storage configured to communicate monitoring information to the database service. The remote data storage can be a customer data storage that collects and processes monitoring information coming from the machine 544. Therefore, the remote data storage can filter and otherwise select the data that gets communicated to the database service. As a result, warning signs and other issues can be reported to the database service about the machine 544 without having to process an excess number of data points coming from the machine 544.

The user may not only have access to the monitoring information 550 about the machine 544, but the user may also have access to all kinds of relevant information pertaining to the record 502. In FIG. 5F, the user may select the knowledge tab 560 to expose knowledge articles 562, similar cases 564, milestones 566, and experts 568. The database service can include a database of knowledge articles that provide information to resolve different customer issues. Rather than opening a separate window or application, the database of knowledge articles can be exposed in the same interface as the case feed. A more detailed description of providing knowledge articles in a user interface can be found in U.S. application Ser. No. 13/935,304 entitled, “SYSTEMS AND METHODS FOR CROSS DOMAIN SERVICE COMPONENT INTERACTION” to Beechuk et al., filed Jul. 3, 2013, the entirety of which is incorporated by reference herein and for all purposes.

In addition, the knowledge tab 560 may cause the user interface 500 to also display similar cases 564 to the case 502. The database service may include or have access to another case object that has case information similar to the issue in the case 502. The user interface 500 may also include milestones 566 regarding the case 502 to show important events in the lifecycle of the case 502 that have occurred and that have not yet occurred. The user interface 500 may further include experts 568 that may possess knowledge of the case 502 that the user may contact.

Returning to FIG. 3, at block 324, the entity can be assigned to the record in response to the user input. Thus, the record can be updated to reflect that the entity is assigned to the record from the user input data provided in the publisher. When the assignment of the entity to the record occurs, a feed item associated with the assignment may be provided that is capable of being displayed in the information feed in response to the user input.

In some implementations, not only does the user input cause an update to the record, but also to a plurality of other data objects. For example, a profile object associated with the entity may be updated to reflect that he/she is assigned to the record. Additionally, other objects such as a calendar object associated with the entity may be updated to reflect the assignment. Furthermore, one or more asset objects associated with the one or more machines may be updated to reflect the assignment. The one or more asset objects may be associated with the record upon creation of the record. In some implementations, the one or more asset objects may be synchronized with the second data source that continuously updates the one or more asset objects with monitoring information.

In some implementations, a notification can be sent regarding the assignment to a client device associated with the entity. The notification can include one or more of a phone call, an email message, a social networking message, an SMS message, an MMS message, and an instant message. For example, the entity can be a field agent with a wearable display device, such as Google Glasses. When the field agent is assigned to the record in response to the user input, a post can be made to the information feed. An @mention can be made in the post so that the field agent is able to see the post on their news feed. In addition or in the alternative, the field agent can receive an email. In addition or in the alternative, the field agent can receive a visual feedback element to display in their wearable display device. The notification can include not only the assignment to the record, but also include additional information regarding the record. This can include, for example, the location and/or route to the one or more machines and the monitoring information about the one or more machines. Thus, the field agent may be able to apprehend the issue about the one or more machines efficiently by reducing the amount of information the field agent must pull from other data sources.

Where the first data source is a wearable display device associated with the entity, the wearable display device may enable the entity to readily interact with the user at the service console in real-time. By way of an example, when a field agent is assigned to the record, the field agent can receive a notification on their wearable display device, which can include a map to the machine at issue. Other information about the machine at issue can also be surfaced in the wearable display device, including diagnostic information. The field agent can quickly locate the machine at issue using the map. In some embodiments, the field agent can pull up a detailed map of the area, including a detailed map of the building in which the machine at issue is located. The field agent may also be able to take a photograph of the machine at issue to assist in troubleshooting. The user at the service console may receive the photograph and may draw on the photograph. The user at the service console may then provide instructions to the field agent by posting to the feed. In some embodiments, an interactive meeting may be initiated between the field agent and the user at the service console. The interactive meeting can be a co-browsing session established through the publisher.

By providing the publisher with the ability to expose information from a plurality of data sources and to quickly assign entities to the record accordingly, the publisher can be provided with enhanced functionality and workflow. In some implementations, the aforementioned methods and systems of integrating data from a plurality of data sources for assigning an entity to a database record in a database service can be applied to a number of contexts. This can include but is not limited to a service context and a sales context.

By way of an example, a customer service issue regarding a malfunctioning machine may come to a customer service representative operating a service console. The service console may include a publisher and a case feed for each case. The issue may come to the attention of the customer service representative when the machine's user hits a support button. The customer service representative may create a case or pull up a case regarding the malfunctioning machine. The customer service representative may desire to dispatch a service technician with the appropriate skills and with available time slots to address the issue. In some implementations, the customer service representative may pull up only service technicians that have the appropriate account levels for servicing the client with the malfunctioning machine. In some implementations, the customer service representative may pull up the location of service technicians to determine their proximity to the malfunctioning machine. Using the publisher, the customer service representative can load a map showing a geolocation of each of the service technicians that have the appropriate skills and available time slots. Those without the available time slots or the appropriate skills do not show up on the map. The publisher may also surface information about the malfunctioning machine, such as the machine's location, diagnostic information, user information, and historical information. Thus, the service technician can know information about the machine and its issue and not just its location. Moreover, the service technician can know the machine's usage, who to speak to, the number of years the user has used the machine, etc. The customer service representative can assign the service technician to the case, and a notification can be sent to the assigned service technician. The assigned service technician may receive an email message, a text message, or a social networking message, where the message can include information about the machine to assist the assigned service technician.

By way of another example, an accounts manager may desire to assign an opportunity to sales representatives selling within a certain region or regions. The accounts manager may use a publisher to cause a map to display, and the accounts manager may draw the area he/she is interested in prospecting in for potential sales representatives. The publisher can return all of the sales representatives within the drawn region of the map to show all the people who sell in that region. In some implementations, the accounts manager may apply a logic to narrow the possible sales representatives. For example, the logic can include only sales representatives that sell X, Y, or Z widgets. If there are multiple opportunities, the logic can include, for example, only displaying opportunities that are potentially worth $15 million or more. Once the pool of possible sales representatives or the pool of opportunities is narrowed, the sales representative may be assigned to a specific opportunity for the region. The selected sales representative may be notified that he/she has been assigned to a particular opportunity for the region.

By way of another example, a project manager may have a plurality of different tasks at different locations to assign to employees. The project manager may surface a geolocation of each of the employees and assign certain tasks to certain employees. The employee may receive notification of their newly assigned task and its location. In another example, a delivery manager for a food vendor may desire to dispatch food delivery vehicles to various locations where orders have been placed. The delivery manager may ascertain the location of each of its food delivery vehicles as well as what items the food delivery vehicles are carrying. The delivery manager may assign the delivery vehicles to appropriate destinations. The driver of the food delivery vehicle may receive notification of a new destination to deliver on their client device.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system for integrating data from data sources for assigning an entity to a database record in a database service, the system comprising:
a database storing one or more records, the database running on one or more instances associated with the database service;
a first data source;
a second data source external to the database service; and
one or more processors associated with the one or more instances, the one or more processors capable of executing one or more instructions configured to cause:
providing user interface data in a user interface, the user interface data associated with a record stored using the database service, the user interface including a publisher and an information feed, the publisher configured to publish information to the information feed;
receiving an attribute regarding an entity from the first data source;
receiving monitoring information for one or more machines from the second data source, the one or more machines configured to communicate the monitoring information about the one or more machines over a network;
providing the attribute and the monitoring information, the attribute and the monitoring information capable of being displayed in the user interface;
receiving user input data indicating a user input associated with the publisher; and
assigning the entity to the record in response to the user input.

2. The system of claim 1, wherein the attribute includes at least one of a geolocation, a skill, and an availability regarding the entity.

3. The system of claim 1, wherein the monitoring information includes at least one of a geolocation, diagnostic information, user information, and historical information about the one or more machines.

4. The system of claim 1, wherein the record is a customer relationship management (CRM) object, the CRM object being one of: a lead, a case, an account, an opportunity, a task, a contact, a campaign, a contract, an event, and a custom object.

5. The system of claim 1, wherein the publisher is configured to provide a publisher action, and wherein selection of the publisher action causes the publisher to provide the attribute and the monitoring information in the user interface.

6. The system of claim 1, wherein the one or more processors are further capable of executing one or more instructions to cause:
sending a notification regarding the assignment to a client device associated with the entity.

7. The system of claim 7, wherein the notification includes one or more of a phone call, an email message, a social networking message, an SMS message, an MMS message, and an instant message.

8. The system of claim 1, wherein the one or more processors are further capable of executing one or more instructions to cause:
providing a feed item associated with the assignment capable of being displayed in the information feed in response to the user input.

9. The system of claim 1, wherein providing the attribute and the monitoring information includes providing the attribute and the monitoring information capable of being displayed in the publisher via a mapping application programming interface (API), the mapping API configured to enable integration of a mapping application with the database service.

10. The system of claim 1, wherein the first data source includes a wearable display device associated with the entity.

11. The system of claim 1, wherein the first data source includes a one or more of a skills database and a calendar object associated with the database service.

12. The system of claim 1, wherein the one or more machines include one or more of a: vehicle, an appliance, a sensor, a robot, and an electronic product.

13. A computer-implemented method of integrating data from data sources for assigning an entity to a database record of a database service, the method comprising:
providing user interface data in a user interface, the user interface data associated with a record stored using a database service, the user interface including a publisher and an information feed, the publisher configured to publish information to the information feed;
receiving an attribute regarding an entity from a first data source;
receiving monitoring information for one or more machines from a second data source external to the database service, the one or more machines configured to communicate the monitoring information about the one or more machines over a network;
providing the attribute and the monitoring information, the attribute and the monitoring information capable of being displayed in the user interface;
receiving user input data indicating a user input associated with the publisher; and
assigning the entity to the record in response to the user input.

14. The method of claim 13, wherein the attribute includes at least one of a geolocation, a skill, and an availability regarding the entity.

15. The method of claim 13, wherein the record is a customer relationship management (CRM) object, the CRM object being one of: a lead, a case, an account, an opportunity, a task, a contact, a campaign, a contract, an event, and a custom object.

16. The method of claim 13, further comprising:
sending a notification regarding the assignment to a client device associated with the entity, wherein the notification includes one or more of a phone call, an email message, a social networking message, an SMS message, an MMS message, and an instant message.

17. The method of claim 13, wherein the first data source includes a wearable display device associated with the entity.

18. A non-transitory computer-readable storage medium storing instructions executable by a processor to cause a method to be performed for integrating data from data sources for assigning an entity to a database record in a database service, the method comprising:
providing user interface data in a user interface, the user interface data associated with a record stored using a database service, the user interface including a publisher and an information feed, the publisher configured to publish information to the information feed;
receiving an attribute regarding an entity from a first data source;
receiving monitoring information for one or more machines from a second data source external to the database service, the one or more machines configured to communicate the monitoring information about the one or more machines over a network;
providing the attribute and the monitoring information, the attribute and the monitoring information capable of being displayed in the user interface;
receiving user input data indicating a user input associated with the publisher; and
assigning the entity to the record in response to the user input.

19. The non-transitory computer-readable storage medium of claim 18, wherein the attribute includes at least one of a geolocation, a skill, and an availability regarding the entity.

20. The non-transitory computer-readable storage medium of claim 18, wherein the first data source includes a wearable display device associated with the entity.
